(19) United States
(12) Patent Application Publication
(10) Pub. No.: US 2007/0255881 A1
(43) Pub. Date: Nov. 1, 2007

(54) HOT ATTACH AND DETACH APPLICATION CARTRIDGE INTERNALLY AND EXTERNALLY CONNECTABLE TO COMPUTER HOST

(76) Inventor: San-Hai Lin, Si Jhih City (TW)

Correspondence Address: SCHMEISER, OLSEN & WATTS, 22 CENTURY HILL DRIVE, SUITE 302, LATHAM, NY, 12110, US

(21) Appl. No.: 11/775,488

(22) Filed: Jul. 10, 2007

Related U.S. Application Data
(63) Continuation-in-part of application No. 11/269,438, filed on Nov. 8, 2005.

(51) Int. Cl. G06F 13/00

(52) U.S. Cl. 710/302

(57) ABSTRACT

An improved hot attach & detach application cartridge that can be externally or internally connected to a computer host easily, comprises a portable computer bracket that is specifically designed to enclose and electrically connect the application cartridge to a mother board of a computer host, wherein the portable computer bracket comprises a circuit board and an ejector that allow the application cartridge to install and electrically connect to the computer host via the circuit board of the computer bracket easily. The application cartridge can be disconnected and detached from the computer host without any difficulty by pushing the ejector of the computer bracket to eject the application cartridge.

### RELATED APPLICATION

The present invention is a continuation-in-part of co-pending U.S. patent application Ser. No. 11/269,438, filed 11/08/2005 and entitled “HOT ATTACH & DETACH APPLICATION CARTRIDGE INTERNALLY AND EXTERNALLY CONNECTABLE TO COMPUTER HOST” and is incorporated herein by reference in its entirety.

1. FIELD OF THE INVENTION

The present invention relates to a hot attach & detach application cartridge, and more particularly to a hot attach & detach application cartridge that may be externally connected to a computer host via a cable and USB connectors, or inserted into a computer bracket of the computer host to internally connect to the computer host via an adapter module and SATA connectors.

2. BACKGROUND OF THE INVENTION

In response to the prosperous developments in the information industrial fields and the wide application of computers in recent years, various kinds of peripherals have been developed and introduced into the market. Particularly, the electronic industry has quickly entered the multimedia era, and a huge amount of audio-visual data is accessed at high speed. To enable users to conveniently use many portable peripherals, such as removable hard drive, CD-ROM, CD-RW, DVD-ROM, these peripherals are provided with USB interface to be “plug and play”.

Please refer to FIG. 1, most of the currently commercially available desktop or notebook computers include a computer host 1 having one or more USB connectors 11 provided on a front panel of the computer host 1, so that a peripheral 12 may be connected to the computer host 1 via a USB flat cable 13. A SATA connector is another type of hot attach & detach connector that provides even faster transmission speed than the USB connector, and is typically used on computers and servers of new generation. Since the super-high transmission speed of SATA is restricted by the length of the connecting flat cable thereof, it is not advisable to use a long flat cable when a high-speed transmission is desired. This is why most computer manufacturers do not provide sockets for SATA connectors on the front panel of the computer host.

Moreover, peripherals with hot attach & detach SATA connectors usually have sizes only suitable for use in bays on an initial corresponding computer host but not bays on other computers. It is therefore apparently difficult to externally connect a peripheral to a computer host via the SATA connector.

It is therefore tried by the inventor to develop a hot attach & detach application cartridge that may be externally connected to a computer host via a cable and USB connectors, or inserted into a bay on the computer host to internally connect to the computer host via an adapter module and SATA connectors.

### SUMMARY OF THE INVENTION

A primary object of the present invention is to provide a hot attach & detach application cartridge that may be externally connected to a computer host via a cable and USB connectors, or inserted into a bay on the computer host to internally connect to the computer host via an adapter module and SATA connectors.

To achieve the above and other objects, the present invention provides a hot attach & detach application cartridge that can be externally or internally connected to a computer host easily. The improved application cartridge of the present invention comprises a portable computer bracket that is specifically designed to enclose and electrically connect an application cartridge to a mother board of a computer host, wherein the application cartridge is installed within the computer bracket to electrically connect to the computer host via a circuit board of the computer bracket. The application cartridge of the present invention can be disconnected and detached from the computer host by pushing the ejector of the computer bracket.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows an example of a conventional hot attach & detach arrangement;

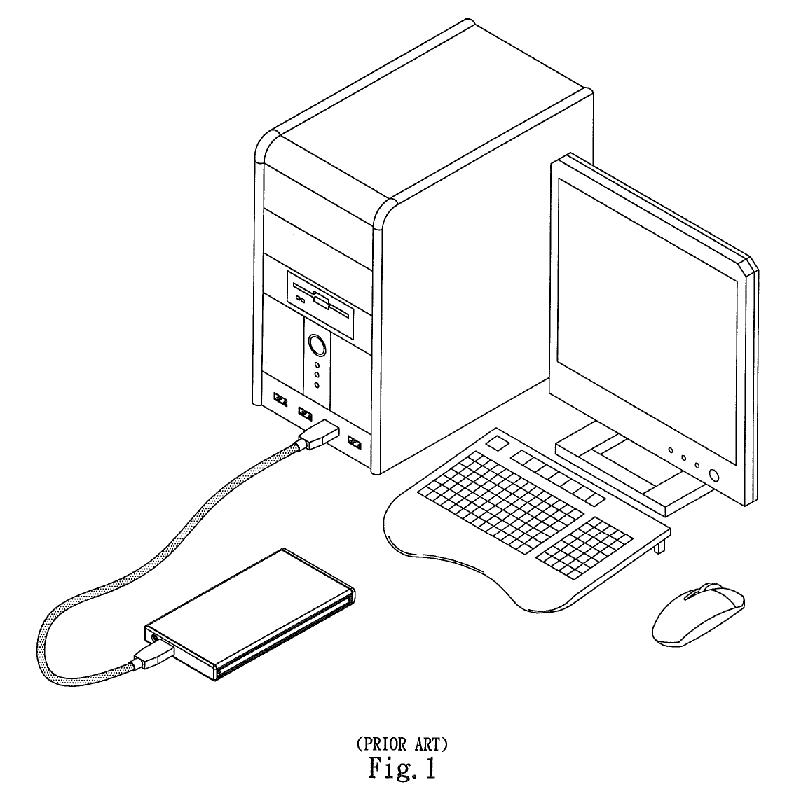

FIG. 2 is an exploded perspective view of a portable computer bracket in accordance with a preferred example of the present invention;

FIG. 3 shows a 3-D assembled portable computer bracket in accordance with the preferred example of the present invention;

FIG. 4 shows the portable computer bracket is installed into a bay of a computer host in accordance with the preferred example of the present invention;

FIG. 5 illustrates an application cartridge inserted and integrated into a slot of the computer bracket; and

FIG. 6 shows a 3-D view of integrating the application cartridge with the computer bracket in the computer host.

### DETAILED DESCRIPTION OF THE PREFERRED EMBODIMENTS

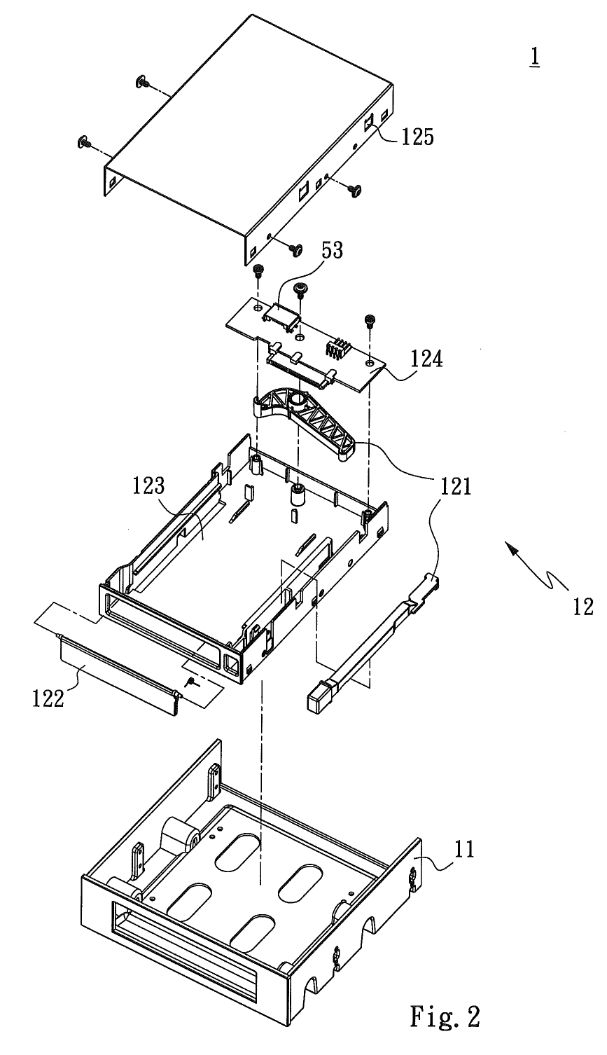

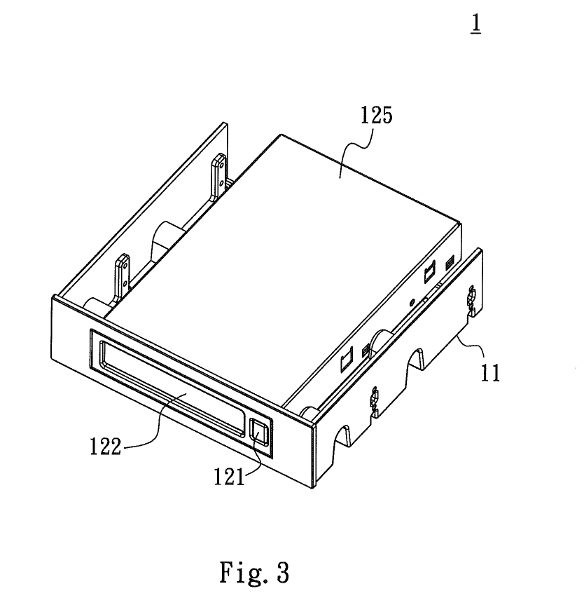

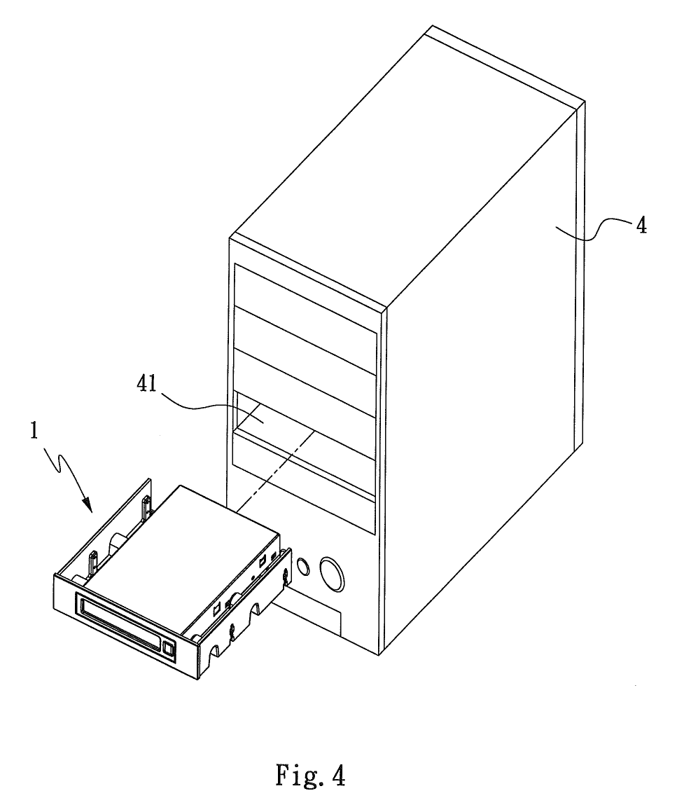

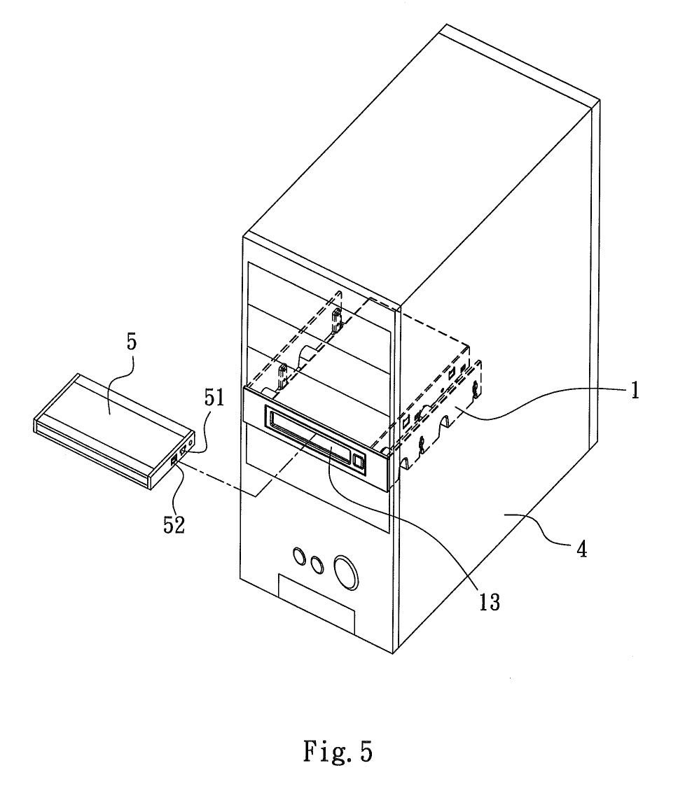

Please refer to FIG. 2, an exploded perspective view of a portable computer bracket in accordance with a preferred example of the present invention. As shown, the hot attach & detach application cartridge of the present invention comprises a computer bracket 1 that is easily to install in the computer host 4 for integrating with an application cartridge 5. The portable computer bracket 1 of the present invention is designed to be detached and reinstalled into the computer host 4 without much difficulty. FIG. 2 shows that the portable computer bracket 1 comprises an outer body 11 and a top unit 12, wherein the top unit 12 comprises an ejector 121, a sliding door 122, a middle body 123, a circuit board 124 and a top cover 125. The ejection 121 is assembled in the middle body 123 and the circuit board 124 is integrated on the top portion of the backside of the middle body 123. An adapter module is provided on the circuit board 124 at a predetermined position with a SATA male connector 53. The top cover 125 is then used to cover over the middle body 1, in which the assembled top unit 12 is then integrated in the space of the outer body 11, the completed assembly portable computer bracket 1 is shown in FIG. 3. Refer to FIG. 4, the assembled portable computer bracket 1 is installed into the bay or slot 41 of the computer host 4 as shown in the drawing. FIG. 5 illustrates an application cartridge 5 inserted and integrated into a slot 13 of the portable computer bracket 1. The portable computer bracket 1 is specifically designed for installation of the application cartridge 5 to the computer host 4. The application cartridge 5 is pushed into the slot 13 of the portable computer bracket 1 easily to electrically connect to the circuit board 124 of the portable computer bracket 1 which is also electrically connected to the computer host 4.

The application cartridge 5 can be removed or detached from the computer host 4 without any difficulty by pushing the ejector 121 of the portable computer bracket 1 to disconnect and eject the application cartridge 5 out of the portable computer bracket 1. The application cartridge 5 of the present invention comprises a SATA female connector 51 that is corresponding to the SATA male connector 53 on the adapter module of the circuit board 124, and a USB female connector that can be utilized to connect to the computer host 4 via a UBS flat cable, or directly connect to the circuit board 124 of the portable computer bracket 1.

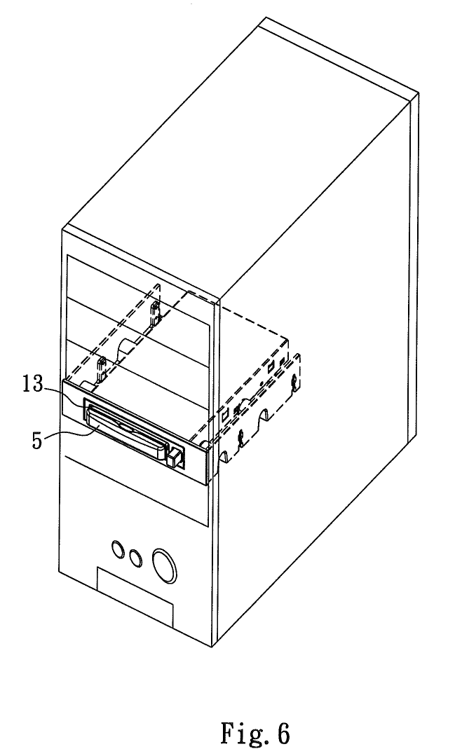

When the application cartridge 5 is pushed into the computer bracket 1, the backside of the application cartridge 5 comes in contact with the circuit board 124 of the portable computer bracket 1 immediately. The SATA female connector 51 of the application cartridge 5 is electrically connected to the computer host 4 through the SATA connector on the circuit board 124 of the portable computer bracket 1 as shown in FIGS. 5 and 6. Once the application cartridge 5 is inserted into the slot 13 of the portable computer bracket 1 shown in FIGS. 5 and 6, the SATA female connector 51 of the application cartridge 5 is directly engaged with the SATA male connector 53 of the adapter module on the circuit board 124 of the portable computer bracket 1. In other words, the portable computer bracket 1 of the present invention is specifically designed to enclose and electrically connect the application cartridge 5 to the computer host 4.

In the event when the computer host 4 does not internally include a SATA male connector 53 in accordance with another preferred example of the present invention. In other words, when the computer host 4 does not have space for the portable computer bracket 1, the application cartridge 5 can be otherwise connected to the computer host 4 via a USB flat cable (not shown), which has a first end plugged into the USB female connector on the application cartridge 5 and a second end plugged into a USB connector provided on a front panel of the computer host 4. As a matter of fact, the application cartridge 5 of the present invention can be connected to the computer host 4 either internally through the portable computer bracket 1 or externally through the USB flat cable.

With the above arrangements, the application cartridge 5 may be externally connected to the computer host 4 via the USB flat cable 33, or inserted into the slot 13 of the portable computer bracket 1 to connect to the computer host 4 via the SATA male connector 53 on the circuit board 124 of the portable computer bracket 1. In brief, the application cartridge 5 allows a user to select either to internally or externally hot attach or detach the application cartridge 5 to or from the computer host 4.

What is claimed is:

1. A hot attach & detach application cartridge, capable of connecting internally or externally to a computer host, comprising:
a portable computer bracket, that is installed into a bay of a computer host to electrically connect to a main board of the computer host, wherein the portable computer bracket comprises an ejector and a circuit board; and
an application cartridge having a hot attach & detach SATA female connector at a predetermined position, wherein the application cartridge is installed in the portable computer bracket to electrically connect to the main board of the computer host via the computer bracket.

2. The application cartridge of claim 1, wherein the portable computer bracket comprises a hot attach & detach SATA male connector on its circuit board that is corresponding to the hot attach & detach SATA female connector of the application cartridge, and is electrically engaged to the application cartridge and the main board of the computer host.

3. The application cartridge of claim 1, wherein the application cartridge is installed into the computer bracket to electrically connected to the computer host via the circuit board of the computer bracket, the application cartridge is disconnected and detached by pushing the ejector to eject the application cartridge out of the computer bracket.
